(19) United States
(12) Patent Application Publication
(10) Pub. No.: US 2020/0104741 A1
(43) Pub. Date: Apr. 2, 2020

(54) METHOD OF TRAINING ARTIFICIAL INTELLIGENCE TO CORRECT LOG-LIKELIHOOD RATIO FOR STORAGE DEVICE

(71) Applicant: STORART TECHNOLOGY CO., LTD., Hsinchu City (TW)

(72) Inventors: HSIANG-EN PENG, HSINCHU CITY (TW); SHENG-HAN WU, HSINCHU CITY (TW)

(21) Appl. No.: 16/359,288

(22) Filed: Mar. 20, 2019

(30) Foreign Application Priority Data
Sep. 28, 2018 (TW) 107134386

(51) Int. Cl. G06N 20/00; G06F 11/10; G06K 9/62; G06F 17/18; G06N 3/04

(52) U.S. Cl. CPC G06N 20/00; G06F 11/1068; G06N 3/04; G06F 17/18; G06K 9/6267

(57) ABSTRACT

A method of training artificial intelligence to correct a log-likelihood ratio for a storage device is provided, which includes steps of: defining various storing states; classifying memory units; calculating a strong correct ratio of the number of the memory units classified in a strong correct region to the number of the memory units classified in the strong correct region and a weak correct region; calculating an strong error ratio of the number of the memory units classified in an strong error region to the number of the memory units classified in the strong error region and a weak error region; calculating the number of the memory units classified in the weak correct and error regions to obtain a histogram parameter; inputting the ratios and parameter to an artificial intelligence neural network system; and using machine learning to analyze a log-likelihood ratio.

### CROSS-REFERENCE TO RELATED PATENT APPLICATION

This application claims the benefit of priority to Taiwan Patent Application No. 107134386, filed on Sep. 28, 2018. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a storage device, and more particularly to a method of training artificial intelligence to correct a log-likelihood ratio of a storage device.

### BACKGROUND OF THE DISCLOSURE

Memories are seeing widespread applications in recent years. However, memories may be damaged by multiple times of erasing and writing data, resulting in an increased probability of error and a significantly reduced reliability of the non-volatile memory. Therefore, by applying design techniques such as error correction techniques, the reliability of the non-volatile memory can be improved, so that the lifetime of a product is prolonged and the operation state of the product is more stable.

An error correction module used for correcting error data read by the non-volatile memory is disposed in a control circuit of the memory to eliminate error caused by external factors in the non-volatile memory, thereby prolonging the lifetime of the non-volatile memory. A common error correction coding technology is such as a Bose-Chaudhuri-Hocquenghem (BCH) coding technology, which is capable of fast computation and has a correction capability that increases with the increase of the number of redundant bits. However, with the improvement of manufacturing technologies of the non-volatile memory, the BCH coding technology has been unable to provide sufficient correction capability. Therefore, a Low Density Parity Code (LDPC) error correction technology currently being used in data storage is widely adopted in the field of communication and has a strong correction capability.

### SUMMARY OF THE DISCLOSURE

In response to the above-referenced technical inadequacies, the present disclosure provides a method of training artificial intelligence to correct a log-likelihood ratio for a storage device including a plurality of memory units each storing one or more bit values. The method includes the following steps: (a) defining a plurality of storing states including a strong correct region, a weak correct region, a strong error region and a weak error region; (b) classifying each of the memory units into the strong correct region, the weak correct region, the strong error region or the weak error region, according to the storing state of each of the memory units; (c) calculating a strong correct ratio of the number of the memory units classified in the strong correct region to the number of the memory units classified in the strong correct region and the weak correct region; (d) calculating a strong error ratio of the number of the memory units classified in the strong error region to the number of the memory units classified in the strong error region and the weak error region; (e) calculating the number of the memory units classified in the weak correct region and the weak error region to obtain a histogram parameter; (0 inputting the strong correct ratio, the strong error ratio and the histogram parameter to an artificial intelligence neural network system; and (g) using machine learning to analyze a practical log-likelihood ratio based on the strong correct ratio, the strong error ratio and the histogram parameter.

As described above, the present disclosure provides the method of training artificial intelligence to correct the log-likelihood ratio for the storage device, which can analyze the practical log-likelihood ratio based on the strong correct ratio, the strong error ratio and the histogram parameter by using machine learning with the artificial intelligence neural network system. The analyzed practical log-likelihood ratio replaces the initial log-likelihood ratio or the previous log-likelihood ratio, by which the decoder cannot decode the bit values stored in the memory units. Accordingly, the present disclosure can achieve an effect of correcting the log-likelihood ratio. Furthermore, the decoder can successfully decode the bit values stored in the memory units based on the practical log-likelihood ratio, and the success rate of decoding the bit values can be larger than the success rate threshold. Therefore, the probability of accessing the correct bit values in the memory units can be increased.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a flowchart of a method of training artificial intelligence to correct a log-likelihood ratio for a storage device according to a first embodiment of the present disclosure.

FIG. 2 is a flowchart of a method of training artificial intelligence to correct a log-likelihood ratio for a storage device according to a second embodiment of the present disclosure.

FIG. 3 is a flowchart of a method of training artificial intelligence to correct a log-likelihood ratio for a storage device according to a third embodiment of the present disclosure.

FIG. 4 is a flowchart of a method of training artificial intelligence to correct a log-likelihood ratio for a storage device according to a fourth embodiment of the present disclosure.

FIG. 5 is a flowchart of a method of training artificial intelligence to correct a log-likelihood ratio for a storage device according to a fifth embodiment of the present disclosure.

FIG. 6 is a flowchart of a method of training artificial intelligence to correct a log-likelihood ratio for a storage device according to a sixth embodiment of the present disclosure.

FIG. 7 is a flowchart of a method of training artificial intelligence to correct a log-likelihood ratio for a storage device according to a seventh embodiment of the present disclosure.

FIG. 8 is a graph of the number of single-level cells verse threshold voltages to which the method of training artificial intelligence to correct the log-likelihood ratio of the storage device is applied according to the embodiments of the present disclosure.

FIG. 9 is a graph of the number of triple-level cells verse threshold voltages to which the method of training artificial intelligence to correct the log-likelihood ratio of the storage device is applied according to the embodiments of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

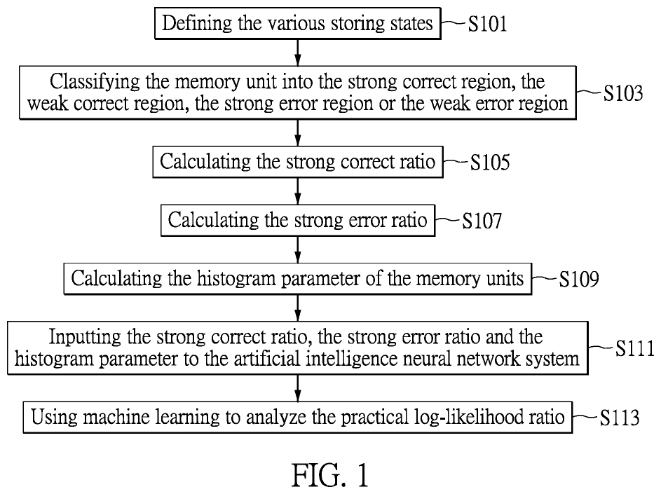

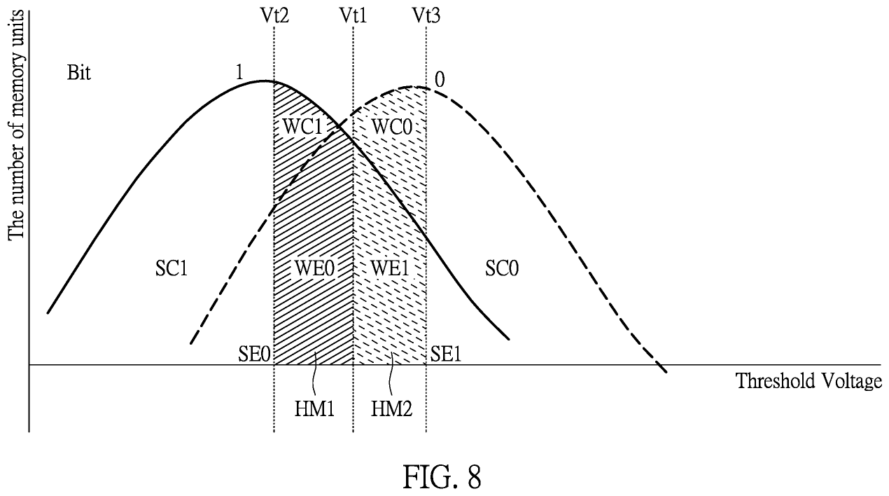

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like. Reference is made to FIGS. 1 and 8, FIG. 1 is a flowchart of a method of training artificial intelligence to correct a log-likelihood ratio of a storage device according to a first embodiment of the present disclosure, and FIG. 8 is a graph of the number of single-level cells verse threshold voltages to which the method of training artificial intelligence to correct the log-likelihood ratio of the storage device is applied according to the embodiments of the present disclosure.

As shown in FIG. 1, the method of training artificial intelligence to correct the log-likelihood ratio of the storage device includes the following steps S101 to S113. The storage device includes a plurality of memory units each storing one or more bit values, wherein each of the bit values is logic “0” or logic “1”.

In step S101, a plurality of storing states including strong correct (SC), weak correct (WC), strong error (SE) and weak error (WE) are defined.

In step S103, the memory unit is classified into a strong correct region, a weak correct region, a strong error region or a weak error region according to the storing state of the memory unit, that is, according to a correct probability and an error probability of accessing the bit values by the memory unit. After the classification of the memory units is completed, next step S105 is performed.

In practice, a plurality of probability thresholds or a plurality of probability ranges that respectively correspond to the strong correct region, the weak correct region, the strong error region and the weak error region may be defined. The memory units may be classified according to a comparison result of the probability thresholds or the probability ranges with the correct probability and the error probability of accessing the bit values by the memory units.

For example, the memory unit has a high correct probability of accessing the bit values; for example, the correct probability is equal to or larger than a correct probability threshold, and accordingly the memory unit is classified into the strong correct region. In contrast, the memory unit has a low correct probability of accessing the bit values, for example, the correct probability is lower than the correct probability threshold, and accordingly the memory unit is classified into the weak correct region. The memory unit has a high error probability of accessing the bit values, for example, the error probability is equal to or larger than an error probability threshold, and accordingly the memory unit is classified in the strong error region. In contrast, the memory unit has a low error probability of accessing the bit values, for example, the error probability is lower than the error probability threshold, and accordingly the memory unit is classified in the weak error region.

As shown in FIG. 8, an entire region formed by the two curves is divided into a plurality of regions representing different storing states based on sensing voltages Vt1, Vt2, Vt3. The curve representing the bit value of logic “1” is used for the classification of the memory unit that intends to store the bit value of logic “1”. For example, the memory unit is classified into a strong correct region SC1, a weak correct region WC1, a strong error region SE1 or a weak error region WE1.

If the memory unit intends to access new bit values Bit each being logic “1”, original bit values Bit previously stored in the memory unit may first be erased and then the new bit values Bit each being logic “1” are accessed by the memory unit, or all of the original bit values Bit and the new bit values are stored in the memory unit.

For example, the memory unit accesses the bit value Bit of logic “1” four times, that is, four bit values Bit each being logic “1” are accessed by the memory unit, wherein the three of the bit values Bit are correctly accessed by the memory unit, while the other one of the bit values Bit that is logic “1” is incorrectly determined as logic “0” to be stored in the memory unit. As a result, the correct probability of accessing the bit values by the memory unit is 75%, which is larger than the correct probability threshold of 70%, and accordingly the memory unit is classified into the strong correct region SC1. It should be understood that the correct probability threshold for the definition of the storing states may be adjusted according to actual requirements.

On the other hand, as shown in FIG. 8, the curve representing the bit value Bit of logic “0” is used for the classification of the memory units that intends to store the bit value of logic “0”. For example, the memory unit is classified into a strong correct region SC0, a weak correct region WC0, a strong error region SE0 or a weak error region WE0.

For example, the memory unit accesses the bit value Bit of logic “0” thrice, that is, three bit values Bit each being logic “0” are accessed by the memory unit, wherein only two of the bit values Bit each being logic “0” are correctly accessed by the memory unit. Accordingly, the correct probability of accessing the bit values by the memory unit is 67%, which is smaller than the correct probability threshold of 70%, and accordingly the memory unit is classified into the weak correct region WC0.

As another example, the memory unit accesses the bit value Bit of logic “1” four times, that is, four bit values Bit each being logic “0” are accessed by the memory unit, wherein all of the four bit values Bit are incorrectly determined as logic “1” to be stored in the memory unit. Accordingly, the error probability of accessing the bit values by the memory unit is 100%, which is larger than the error probability threshold of 90%, and accordingly the memory unit is classified into the strong error region SE0.

In step S105, a strong correct ratio (SCR) of the number of the memory units in the strong correct region to the number of the memory units in the strong and weak correct regions is calculated, which is expressed by the following equation:

$$SCR = \frac{SC}{SC + WC}$$

wherein SCR represents the strong correct ratio, SC represents the number of the memory units in the strong correct region, and WC represents the number of the memory units in the weak correct region.

If some or all of the memory units intend to store the bit value Bit of logic “1”, an area of the strong correct region SC1 and an area of the weak correct region WC1 as shown in FIG. 8 are respectively calculated and then summed up. Finally, the strong correct ratio of the area of the strong correct region SC1 to the areas of the strong correct region SC1 and the weak correct region WC1 is calculated.

If some or all of the memory units intend to store the bit value Bit of logic “0”, an area of the strong correct region SC0 and an area of the weak correct region WC0 as shown in FIG. 8 are respectively calculated and then summed up. Finally, the strong correct ratio of the area of the strong correct region SC0 to the areas of the strong correct region SC0 and the weak correct region WC0 is calculated.

It should be understood that, in practice, the bit values Bit accessed by the memory units includes logic “0” and logic “1”. Therefore, it is necessary to calculate the two strong correct ratios corresponding to the logic “0” and the logic “1” as described above. The two strong correct ratios are used as input parameters to generate a practical log-likelihood ratio in subsequent steps.

In step S107, a strong error ratio (SER) of the number of the memory units in the strong error region to the number of the memory units in the strong and weak error regions is calculated, which is expressed by the following equation:

$$SER = \frac{SE}{SE + WE}$$

wherein SCR represents the strong error ratio, SE represents the number of the memory units in the strong error region, and WE represents the number of the memory units in the weak error region.

If some or all of the memory units intend to store the bit value Bit of logic “1”, an area of the strong error region SE1 and an area of the weak error region WE1 as shown in FIG. 8 are respectively calculated and then summed up.

Finally, the strong error ratio of the area of the strong error region SE1 to the areas of the strong error region SE1 and the weak error region WE1 is calculated.

If some or all of the memory units intend to store the bit value Bit of logic “0”, an area of the strong error region SE0 and an area of the weak error region WE0 as shown in FIG. 8 are respectively calculated and then summed up. Finally, the strong error ratio of the area of the strong error region SE0 to the areas of the strong error region SE0 and the weak error region WE0 is calculated.

It should be understood that, in practice, the bit values Bit accessed by the memory units includes logic “0” and logic “1”. Therefore, it is necessary to calculate the two strong error ratios corresponding to the logic “0” and the logic “1” as described above. The two strong error ratios are used as input parameters to generate the practical log-likelihood ratio in subsequent steps.

In step S109, the number of the memory units classified into the weak correct region and the number of the memory units classified into the weak error region are respectively calculated, and then summed up to obtain a histogram parameter. The histogram parameter may include a first sub-histogram parameter and a second sub-histogram parameter.

For example, the area of the weak correct region WC1 corresponding to the curve representing the bit value of logic “1” as shown in FIG. 8 is calculated. The area of the weak error region WE0 corresponding to the curve representing the bit value of logic “0” as shown in FIG. 8 is calculated. The area of the weak correct region WC1 and the area of the weak error region WE0 are summed up to obtain the first sub-histogram parameter HM1. That is, the first sub-histogram parameter HM1 is equal to a sum of the number of the memory units classified in the weak correct region WC1 and the number of the weak error region WE0. In addition, the area of the weak correct region WC0 corresponding to the curve representing the bit value of logic “0” as shown in FIG. 8 is calculated. The area of the weak error region WE1 corresponding to the curve representing the bit value of logic “1” as shown in FIG. 8 is calculated. The area of the weak correct region WC0 and the area of the weak error region WE1 are summed up to obtain the second sub-histogram parameter HM2.

Alternatively, the area of the weak correct region WC1 and the area of the weak error region WE1 which correspond to the curve representing the bit value of logic “1” as shown in FIG. 8 are summed up to obtain the first sub-histogram parameter HM1. In addition, the area of the weak correct region WC0 and the area of the weak error region WE0 which correspond to the curve representing the bit value of logic “0” as shown in FIG. 8 are summed up to obtain the second sub-histogram parameter HM2.

In step S111, the calculated strong correct ratio, strong error ratio, first sub-histogram parameter and second sub-histogram parameter are used as input parameters to be inputted to an artificial intelligence neural network system (AI-NN).

In step S113, the practical log-likelihood ratio is analyzed based on the strong correct ratio, the strong error ratio and the histogram parameter by using machine learning.

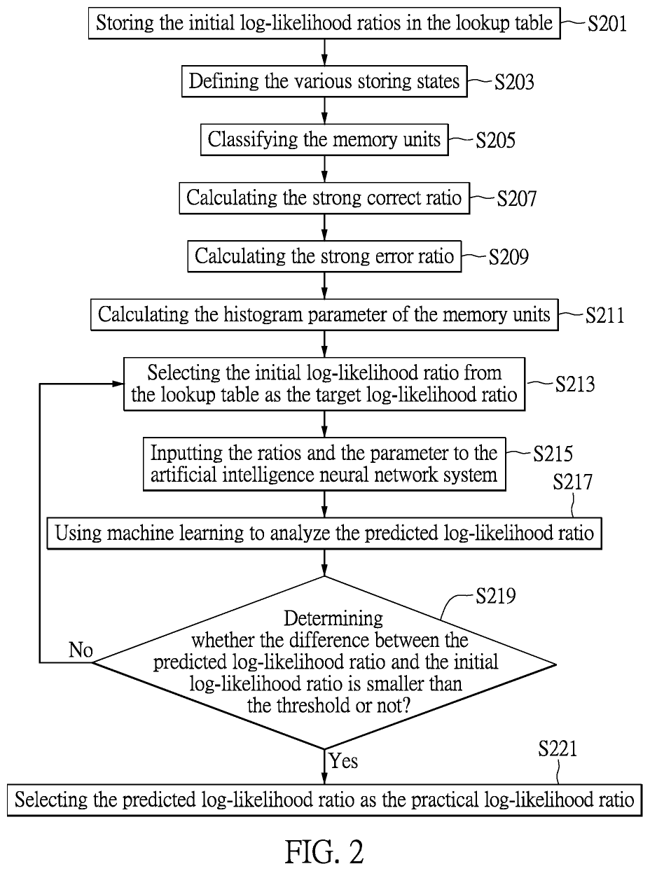

Reference is made to FIG. 2, which is a flowchart of a method of training artificial intelligence to correct a log-likelihood ratio for a storage device according to a second embodiment of the present disclosure. As shown in FIG. 2, the method of training artificial intelligence to correct the log-likelihood ratio of the storage device includes the following steps S201 to S221. The storage device includes the plurality of memory units each storing one or more bit values, wherein each of the bit values is logic “0” or “1”.

In step S201, a plurality of initial log-likelihood ratios are stored in the lookup table.

In step S203, the storing states including the strong correct region, the weak correct region, the strong error region and the weak error region are defined.

In step S205, the memory unit is classified into the strong correct region, the weak correct region, the strong error region or the weak error region.

In step S207, the strong correct ratio of the number of the memory units in the strong correct region to the number of the memory units in the strong and weak correct regions is calculated.

In step S209, the strong error ratio of the number of the memory units in the strong error region to the number of the memory units in the strong and weak error regions is calculated.

In step S211, the number of the memory units classified into the weak correct region and the number of the memory units classified into the weak error region are summed up to obtain the histogram parameter.

In step S213, one of the initial log-likelihood ratios stored in the lookup table is selected as a target log-likelihood ratio.

In step S215, the selected initial log-likelihood ratio, the strong correct ratio, the strong error ratio and the histogram parameter are inputted to the artificial intelligence neural network system.

In step S217, a predicted log-likelihood ratio is analyzed based on the selected initial log-likelihood ratio, the strong correct ratio, the strong error ratio and the histogram parameter by using machine learning.

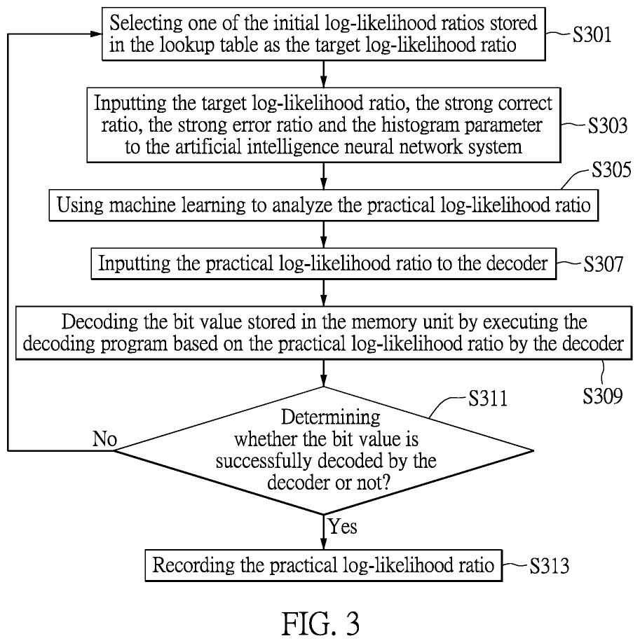

In step S219, whether a difference between the predicted log-likelihood ratio and the initial log-likelihood ratio is smaller than a difference threshold or not is determined. If the difference between the predicted log-likelihood ratio and the initial log-likelihood ratio is not smaller than the difference threshold, another of the initial log-likelihood ratios stored in the lookup table is selected as the target log-likelihood ratio, and then steps S215 to S219 are performed based on the another initial log-likelihood ratio. If the difference between the predicted log-likelihood ratio and the initial log-likelihood ratio is smaller than the difference threshold, the predicted log-likelihood ratio is used as the practical log-likelihood ratio. Reference is made to FIG. 3, which is a flowchart of a method of training artificial intelligence to correct a log-likelihood ratio for a storage device according to a third embodiment of the present disclosure. As shown in FIG. 3, the method of training artificial intelligence to correct the log-likelihood ratio of the storage device includes the following steps S301 to S313. The storage device includes the plurality of memory units each storing the one or more bit values, wherein each of the bit values is logic “0” or “1”.

In step S301, one of the initial log-likelihood ratios stored in the lookup table is selected as the target log-likelihood ratio.

In step S303, the target log-likelihood ratio, the strong correct ratio, the strong error ratio and the histogram parameter are inputted to the artificial intelligence neural network system.

In step S305, the practical log-likelihood ratio is analyzed based on the target log-likelihood ratio, the strong correct ratio, the strong error ratio and the histogram parameter by using machine learning.

In step S307, the practical log-likelihood ratio is inputted to a decoder.

In step S309, the bit value stored in the memory unit is decoded by executing a decoding program based on the practical log-likelihood ratio by the decoder.

In step S311, whether the bit value stored in the memory unit is successfully decoded by the decoder or not is determined. If the bit value stored in the memory unit is not successfully decoded, step S301 is performed again, in which another of the initial log-likelihood ratios stored in the lookup table is selected as the target log-likelihood ratio. If the bit value stored in the memory unit is successfully decoded, step S313 is performed.

In step S313, the practical log-likelihood ratio by which the decoder successfully decodes the bit values stored in the memory unit is recorded.

For example, when the memory unit is classified into the strong correct region, the bit values read over multiple times by the memory unit are all correct, that is, the correct probability is high. Under such circumstances, the decoder may use a larger practical log-likelihood ratio for decoding. Conversely, the decoder performs the decoding program based on a smaller practical log-likelihood ratio for the bit value stored in the memory units classified in the strong error region. As a result, the decoder has a probability to flip the logic bit value of a code word, that is, the decoder flips a misjudged logic bit value of “0” to an original logic bit value of “1”, or flips a misjudged logic bit value of “1” to an original logic bit value of “0”. That is, the decoder may perform a subsequent correction process on the logic bit value misjudged by the memory unit to successfully decode a logic bit value flipped from the misjudged logic bit value. Therefore, the decoder has an improved error correction capability such that a success rate of decoding the logic bit value is increased.

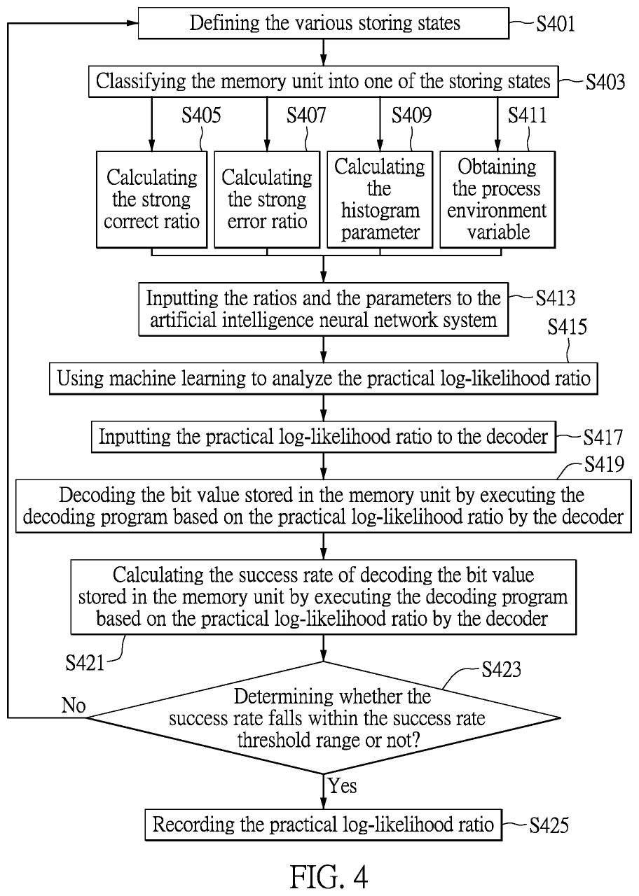

Reference is made to FIG. 4, which is a flowchart of a method of training artificial intelligence to correct a log-likelihood ratio for a storage device according to a fourth embodiment of the present disclosure. As shown in FIG. 4, the method of training artificial intelligence to correct the log-likelihood ratio for the storage device includes the following steps S401 to S425. The storage device includes the plurality of memory units each storing the one or more bit values, wherein each of the bit values is logic “0” or “1”.

In step S401, the storing states including the strong correct region, the weak correct region, the strong error region and the weak error region are defined.

In step S403, the memory units are classified into the storing states such as the strong correct region, the weak correct region, the strong error region and the weak error region respectively.

In step S405, the strong correct ratio of the number of the memory units in the strong correct region to the number of the memory units in the strong and weak correct regions is calculated.

In step S407, the strong error ratio of the number of the memory units in the strong error region to the number of the memory units in the strong and weak error regions is calculated.

In step S409, the number of the memory units classified into the weak correct region and the number of the memory units classified into the weak error region are summed up to obtain the histogram parameter.

In step S411, a process environment variable associated with a process in which the storage device accesses the one or more bit values is obtained.

In step S413, the process environment variable, the strong correct ratio, the strong error ratio and the histogram parameter are inputted to the artificial intelligence neural network system.

In step S415, the practical log-likelihood ratio is analyzed based on the process environment variable, the strong correct ratio, the strong error ratio and the histogram parameter by using machine learning.

In step S417, the practical log-likelihood ratio is inputted to the decoder. In step S419, the bit value stored in the memory unit is decoded by executing the decoding program based on the practical log-likelihood ratio by the decoder.

In step S421, the success rate of decoding the bit value stored in the memory unit by executing the decoding program based on the practical log-likelihood ratio by the decoder is calculated.

In step S423, whether the success rate falls within a success rate threshold range or not is determined. If the success rate does not fall within the success rate threshold range, more storing states such as more regions are redefined based on the success rate of decoding in step S401, or the memory units are reclassified into different storing states and into different regions in S403. If the success rate falls within the success rate threshold range, step S425 is performed.

The above successful probability threshold range may include a strong correct probability range, a weak correct probability range, a strong error probability range and a weak error probability range, which respectively correspond to the strong correct region, the weak correct region, the strong error region and the weak error region. For example, in step S423, whether the success rate of accessing the bit values by the memory unit classified in the strong correct region falls within the strong correct probability range such as 85% to 100% is determined. Alternatively, whether the success rate of accessing the bit values by the memory unit classified in the weak correct region falls within the weak correct probability range such as 70% to 85% is determined

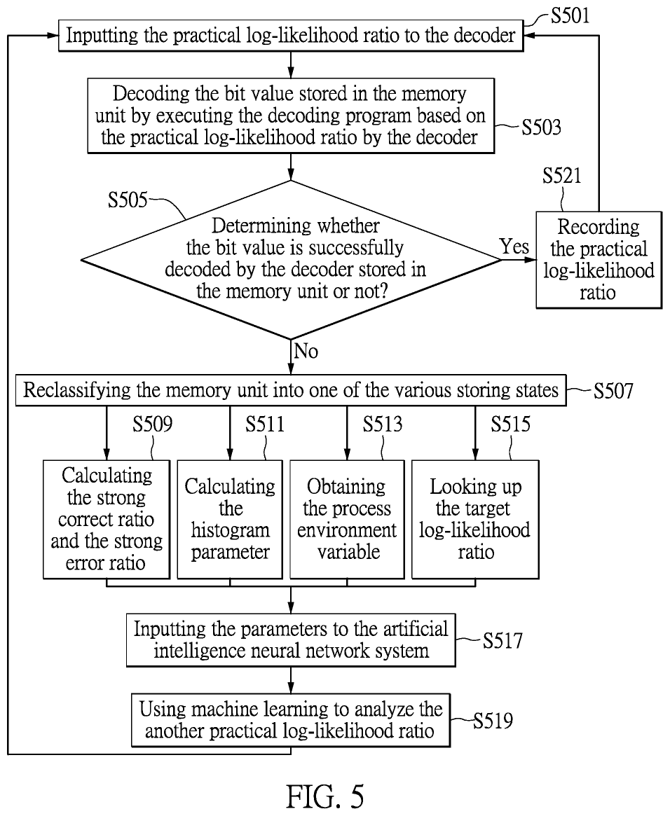

In step S425, the practical log-likelihood ratio is recorded. Reference is made to FIG. 5, which is a flowchart of a method of training artificial intelligence to correct a log-likelihood ratio of a storage device according to a fifth embodiment of the present disclosure. As shown in FIG. 5, the method of training artificial intelligence to correct the log-likelihood ratio of the storage device includes the following steps S501 to S521. The storage device includes the plurality of memory units each the storing one or more bit values, wherein each of the bit values is logic “0” or “1”.

In step S501, the practical log-likelihood ratio is inputted to the decoder. In step S503, the bit value stored in the memory unit is decoded by executing the decoding program based on the practical log-likelihood ratio by the decoder.

In step S505, whether the bit value stored in the memory unit, in particular the memory unit which is classified into the strong correct region, the weak correct region or the weak error region, is successfully decoded by the decoder at a certain success rate or not is determined. If the bit value is not successfully decoded, steps S507 to S519 are performed. If the bit value is successfully decoded, step S521 is performed.

In step S507, the memory unit is reclassified into the strong correct region, the weak correct region, the strong error region or the weak error region, according to whether the bit value stored in the memory unit is successfully decoded. After reclassifying the memory units, the number of memory units in each of the regions may be changed, and the different strong correct ratio, strong error ratio and histogram parameter are calculated in subsequent steps. As a result, the different practical log-likelihood ratio is generated finally.

In step S509, the strong correct ratio of the number of the memory units in the strong correct region to the number of the memory units in the strong and weak correct regions is calculated. In addition, the strong error ratio of the number of the memory units in the strong error region to the number of the memory units in the strong and weak error regions is calculated.

In step S511, the number of the memory units classified into the weak correct region and the number of the memory units classified into the weak error region are summed up to obtain the histogram parameter.

In step S513, the process environment variable associated with the process in which the storage device accesses the one or more bit values is obtained. For example, the process environment variable includes the number of times that the one or more bit values are written in the memory unit, the number of times that the one or more bit values are erased from the memory unit, a process ambient temperature, or combination thereof.

In step S515, one or a set of the initial log-likelihood ratios is looked up in the lookup table as the target log-likelihood ratio.

In step S517, the strong correct ratio, the strong error ratio, the histogram parameter, the process environment variable and the target initial log-likelihood ratio are inputted to the artificial intelligence neural network system.

In step S519, another practical log-likelihood ratio is analyzed based on the strong correct ratio, the strong error ratio, the histogram parameter, the process environment variable and the target initial log-likelihood ratio by machine learning. Then, steps S501 to S505 are performed again based on another practical log-likelihood ratio. In detail, it is determined whether the bit value stored in the memory unit is successfully decoded by executing the decoding program based on another practical log-likelihood ratio by the decoder.

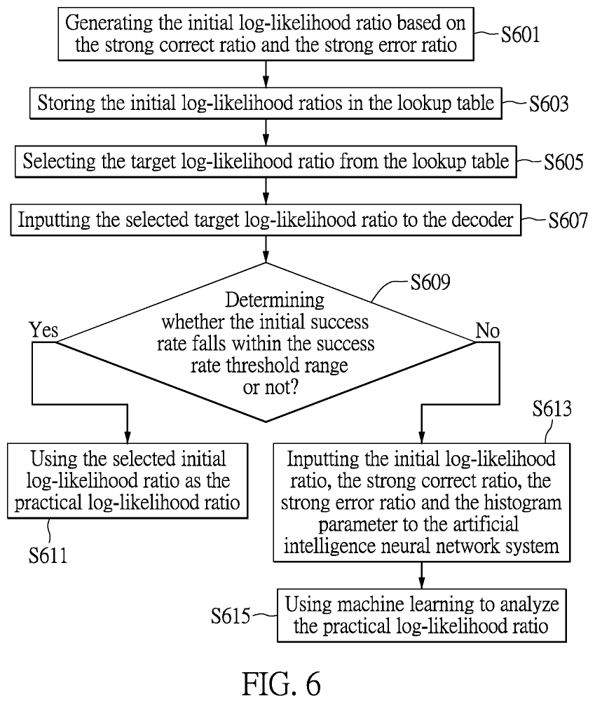

In step S521, the practical log-likelihood ratio by which the decoder successfully decodes the bit values stored in the memory unit is recorded. When the same memory unit accesses other bit values, the decoder decodes the other bit values stored in the memory unit based on the decoding program corresponding to the recorded log-likelihood ratio to successfully decode the other bit values stored in the memory unit. However, when the bit values stored in the memory unit cannot be successfully decoded, another practical log-likelihood ratio by which the decoder successfully decodes the bit values stored in the memory unit is regenerated. Reference is made to FIG. 6, which is a flowchart of a method of training artificial intelligence to correct a log-likelihood ratio for a storage device according to a sixth embodiment of the present disclosure. As shown in FIG. 6, the method of training artificial intelligence to correct the log-likelihood ratio for the storage device includes the following steps S601 to S615. The storage device includes the plurality of memory units each storing the one or more bit values, wherein each of the bit values is logic “0” or “1”.

In step S601, the initial log-likelihood ratios generated based on an initial strong correct ratio and an initial strong error ratio are stored in the lookup table.

The initial strong correct ratio described herein is a ratio of the number of the memory units in the strong correct region to the number of the memory units in the strong correct and weak correct regions. The initial strong error ratio is a ratio of the number of the memory units in the strong e rror region to the number of the memory units in the strong error and weak error regions.

In step S603, one of the initial log-likelihood ratios stored in the lookup table is selected.

In step S605, the selected initial log-likelihood ratio is inputted to the decoder.

In step S607, an initial success rate of decoding the bit value stored in the memory unit by executing the decoding program based on the initial log-likelihood ratio by the decoder is calculated.

In step S609, it is determined whether the initial success rate falls within the success rate threshold range or not. If the initial success rate falls within the success rate threshold range, the initial success rate is used as the practical log-likelihood ratio in step S611. If the success rate does not fall within the success rate threshold range, steps S613 to S615 are sequentially performed.

In step S613, the initial log-likelihood ratio, the strong correct ratio, the strong error ratio and the histogram parameter are inputted to the artificial intelligence neural network system.

In step S615, the practical log-likelihood ratio is analyzed based on the initial log-likelihood ratio, the strong correct ratio, the strong error ratio and the histogram parameter by using machine learning.

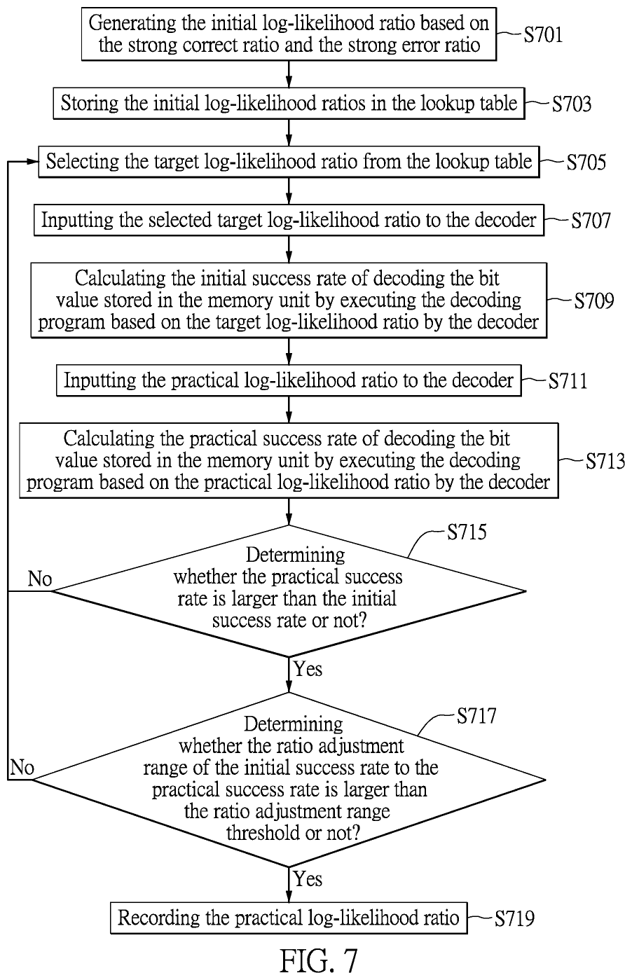

The strong correct ratio and the strong error ratio mentioned in the above steps S611 to S615 may be the same as or different from the initial strong correct ratio and the initial strong error ratio of step S601. As described above, the initial strong correct ratio and the initial strong error ratio may be changed by reclassifying the memory units into the different regions (storing states). Reference is made to FIG. 7, which is a flowchart of a method of training artificial intelligence to correct a log-likelihood ratio for a storage device according to a seventh embodiment of the present disclosure. As shown in FIG. 7, the method of training artificial intelligence to correct the log-likelihood ratio for the storage device includes the following steps S701 to S719. The storage device includes the plurality of memory units each stores the one or more bit values, wherein each of the bit values is logic “0” or “1”.

In step S701, the initial log-likelihood ratios are generated based on the strong correct ratio and the strong error ratio.

In step S703, the initial log-likelihood ratios are stored in the lookup table. In step S705, one of the initial log-likelihood ratios stored in the lookup table is selected as the target log-likelihood ratio.

In step S707, the selected initial log-likelihood ratio that is the target log-likelihood ratio is inputted to the decoder.

In step S709, the initial success rate of decoding the bit value stored in the memory unit by executing the decoding program based on the selected initial log-likelihood ratio, that is the target log-likelihood ratio by the decoder, is calculated.

In step S711, the practical log-likelihood ratio is inputted to the decoder. In step S713, a practical success rate of decoding the bit value stored in the memory unit by executing the decoding program based on the practical log-likelihood ratio by the decoder is calculated.

In step S715, it is determined whether the practical success rate is larger than the initial success rate or not. If the practical success rate is not larger than the initial success rate, step S705 is performed again, in which another of the initial log-likelihood ratios stored in the lookup table is selected as the target log-likelihood ratio. If the practical success rate is larger than the initial success rate, step S717 is performed.

In step S717, whether a ratio adjustment range of the initial success rate to the practical success rate is larger than a ratio adjustment range threshold or not is determined. For example, the ratio adjustment range is 30% or more. If the ratio adjustment range is not larger than the ratio adjustment range threshold, step S705 is performed again, in which another of the initial log-likelihood ratios stored in the lookup table is selected as the target log-likelihood ratio. If the ratio adjustment range is larger than the ratio adjustment range threshold, step S719 is performed.

In step S719, the practical log-likelihood ratio is recorded.

Reference is made to FIG. 8, which is a graph of the number of single-level cells verse threshold voltages to which the method of training artificial intelligence to correct the log-likelihood ratio for the storage device is applied according to the embodiments of the present disclosure. The method of training artificial intelligence to correct the log-likelihood ratio may be applied to the storage device such as a solid state storage device including the single-level cells (SLC) each can store 1 bit value that is logic “0” or “1”.

As shown in FIG. 8, the graph is used for the single-level cells, a vertical axis represents the number of the single-level cells and a horizontal axis represents the threshold voltage values of the single-level cells, and the two curves of logic “0” and logic “1” are formed according to relationship of the number of the memory units with respect to the threshold voltages.

An entire region formed by the curve representing logic “1” is divided into the plurality of storing states including the strong correct region SC1, the weak correct region WC1, the strong error region SE1 and the weak error region WE1 by sensing voltages Vt1, Vt2, Vt3. An entire region formed by the curve representing logic “0” is divided into the plurality of storing states including the strong correct region SC0, the weak correct region WC0, the strong error region SE0 and the weak error region WE0 by the sensing voltages Vt1, Vt2, Vt3. The histogram parameter HM1 may be an entire region including the weak correct region WC1 and the weak error region WE0. The histogram parameter HM2 may be an entire region including the weak correct region WC0 and the weak error region WE1.

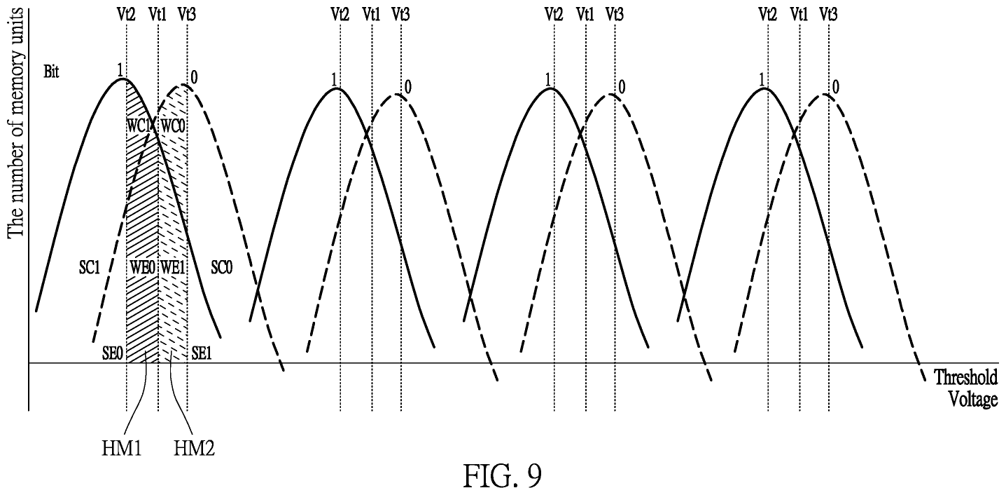

Reference is made to FIG. 9, which is a graph of the number of triple-level cells verse threshold voltages to which the method of training artificial intelligence to correct the log-likelihood ratio for the storage device is applied according to the embodiments of the present disclosure. The method of training artificial intelligence to correct the log-likelihood ratio may be applied to the storage device such as a solid state storage device including the triple-level cells (TLC) each can store 3 bit values each is logic “0” or “1”. Four sets of the two curves of logic “1” and logic “0” are shown in FIG. 9. Each set of the two curves is the same as that shown in FIG. 8.

In summary, the present disclosure provides the method of training artificial intelligence to correct the log-likelihood ratio for the storage device, which can analyze the practical log-likelihood ratio based on the strong correct ratio, the strong error ratio and the histogram parameter by using machine learning with the artificial intelligence neural network system. The analyzed practical log-likelihood ratio replaces the initial log-likelihood ratio or the previous log-likelihood ratio, by which the decoder cannot decode the bit values stored in the memory units. Accordingly, the present disclosure can achieve an effect of correcting the log-likelihood ratio. Furthermore, the decoder can successfully decode the bit values stored in the memory units based on the practical log-likelihood ratio, and the success rate of decoding the bit values can be larger than the success rate threshold. Therefore, the probability of accessing the correct bit values in the memory units can be increased.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method of training artificial intelligence to correct a log-likelihood ratio of a storage device including a plurality of memory units each storing one or more bit values, comprising the following steps:
(a) defining a plurality of storing states including a strong correct region, a weak correct region, a strong error region and a weak error region;
(b) classifying each of the memory units into the strong correct region, the weak correct region, the strong error region or the weak error region, according to the storing state of each of the memory units;
(c) calculating a strong correct ratio of the number of the memory units classified in the strong correct region to the number of the memory units classified in the strong correct region and the weak correct region;
(d) calculating a strong error ratio of the number of the memory units classified in the strong error region to the number of the memory units classified in the strong error region and the weak error region;
(e) calculating the number of the memory units classified in the weak correct region and the weak error region to obtain a histogram parameter;
(f) inputting the strong correct ratio, the strong error ratio and the histogram parameter to an artificial intelligence neural network system; and
(g) using machine learning to analyze a practical log-likelihood ratio based on the strong correct ratio, the strong error ratio and the histogram parameter.

2. The method of claim 1, further comprising steps of:
(h) storing a plurality of initial log-likelihood ratios in a lookup table;
(i) selecting one of the initial log-likelihood ratios from the lookup table as a target log-likelihood ratio;
(j) inputting the target log-likelihood ratio, the strong correct ratio, the strong error ratio and the histogram parameter to the artificial intelligence neural network system;
(k) using machine learning to analyze a predicted log-likelihood ratio based on the target log-likelihood ratio, the strong correct ratio, the strong error ratio and the histogram parameter; and
(l) determining whether a difference between the predicted log-likelihood ratio and the target log-likelihood ratio is smaller than a difference threshold or not, in response to the difference being smaller than the difference threshold, the predicted log-likelihood ratio is used as the practical log-likelihood ratio; in response to the difference being not smaller than the difference threshold, selecting another of the initial log-likelihood ratios from the lookup table as the target log-likelihood ratio in step (j), and then sequentially performing steps (j) to (l) based on the another initial log-likelihood ratio.

3. The method of claim 1, further comprising steps of:
(m) inputting the practical log-likelihood ratio to a decoder;
(n) decoding the bit value stored in each of the memory units by executing a decoding program based on the practical log-likelihood ratio by the decoder;
(o) determining whether the bit value is successfully decoded by the decoder or not, in response to the bit value being successfully decoded, recording the practical log-likelihood ratio; in response to the bit value being not successfully decoded, selecting one of the initial log-likelihood ratios from the lookup table as a target log-likelihood ratio and then performing step (p).
(p) inputting the target log-likelihood ratio, the strong correct ratio, the strong error ratio and the histogram parameter to the artificial intelligence neural network system; and
(q) using machine learning to analyze another practical log-likelihood ratio based on the target log-likelihood ratio, the strong correct ratio, the strong error ratio and the histogram parameter, and then steps (m) to (o) are sequentially performed based on the another practical log-likelihood ratio instead of the one practical log-likelihood ratio.

4. The method of claim 1, further comprising steps of:
(r) inputting the practical log-likelihood ratio to a decoder;
(s) decoding the bit value stored in each of the memory units by executing a decoding program based on the practical log-likelihood ratio by the decoder;
(t) calculating a success rate of decoding the bit value stored in the memory unit by executing the decoding program based on the practical log-likelihood ratio by the decoder; and
(u) determining whether the success rate falls within a success rate threshold range or not, in response to the success rate falling within the success rate threshold range, recording the practical log-likelihood ratio; in response to the success rate not falling within the success rate threshold range, returning to step (a).

5. The method of claim 1, further comprising steps of:
(v) storing a plurality of initial log-likelihood ratios generated based on an initial strong correct ratio and an initial strong error ratio in a lookup table;
(w) selecting one of the initial log-likelihood ratios from the lookup table;
(x) inputting the selected initial log-likelihood ratio to a decoder;
(y) calculating an initial success rate of decoding the bit value stored in the memory unit by executing a decoding program based on the initial log-likelihood ratio by the decoder;
(z) inputting the practical log-likelihood ratio to the decoder;
(aa) calculating a practical success rate of decoding the bit value stored in the memory unit by executing a decoding program based on the practical log-likelihood ratio by the decoder; and
(bb) determining whether the practical success rate is larger than the initial success rate or not, in response to the practical success rate being not larger than the initial success rate, selecting another of the initial log-likelihood ratio from the lookup table in step (w), and then sequentially performing steps (x) to (bb) based on the another initial log-likelihood ratio instead of the one initial log-likelihood ratio; in response to the practical success rate being larger than the initial success rate, recording the practical log-likelihood ratio.

6. The method of claim 5, after determining that the practical success rate is larger than the initial success rate, further comprising steps of:
(cc) determining whether a ratio adjustment range of the initial success rate to the practical success rate is larger than a ratio adjustment range threshold or not, in response to the ratio adjustment range being not larger than the ratio adjustment range threshold, selecting another of the initial log-likelihood ratio from the lookup table in step (w), and then sequentially performing steps (x) to (bb) based on the another initial log-likelihood ratio instead of the one initial log-likelihood ratio, in response to the ratio adjustment range being larger than the ratio adjustment range threshold, recording the practical log-likelihood ratio.

7. The method of claim 1, further comprising steps of:
(dd) storing a plurality of initial log-likelihood ratios generated based on an initial strong correct ratio and an initial strong error ratio in a lookup table;
(ee) selecting one of the initial log-likelihood ratios from the lookup table;
(ff) inputting the selected initial log-likelihood ratio to a decoder;
(gg) calculating an initial success rate of decoding the bit value stored in the memory unit by executing a decoding program based on the initial log-likelihood ratio by the decoder;
(hh) determining whether the initial success rate falls within an success rate threshold range or not, in response to the initial success rate falling within the success rate threshold range, the initial log-likelihood ratio is used as the practical initial log-likelihood ratio, in response to the initial success rate not falling within the success rate threshold range, step (ii) is performed.
(ii) inputting the initial log-likelihood ratio, the strong correct ratio, the strong error ratio and the histogram parameter to the artificial intelligence neural network system; and
(jj) using machine learning to analyze the practical log-likelihood ratio based on the initial log-likelihood ratio, the strong correct ratio, the strong error ratio and the histogram parameter.

8. The method of claim 1, further comprising steps of:
(kk) inputting the practical log-likelihood ratio to a decoder;
(ll) decoding the bit value stored in each of the memory units by executing a decoding program based on the practical log-likelihood ratio by the decoder; and
(mm) determining whether the bit value stored in each of the memory units classified in the strong correct region or the weak correct region is successfully decoded by the decoder or not, in response to the bit value being successfully decoded, recording the practical log-likelihood ratio; in response to the bit value being not successfully decoded, reclassifying each of the memory units in step (b) and then step (c) is performed.

9. The method of claim 1, further comprising steps of:
(nn) obtaining a process environment variable associated with a process in which the storage device accesses the one or more bit values;
(oo) inputting the process environment variable, the strong correct ratio, the strong error ratio and the histogram parameter to the artificial intelligence neural network system; and
(pp) using machine learning to analyze the practical log-likelihood ratio based on the process environment variable, the strong correct ratio, the strong error ratio and the histogram parameter.

10. The method of claim 9, wherein the process environment variable includes the number of times that the one or more bit values are written in each of the memory units, the number of times that the one or more bit values are erased from each of the memory units, or combination thereof.
